(19) United States
(12) Patent Application Publication
(10) Pub. No.: US 2018/0142477 A1
(43) Pub. Date: May 24, 2018

(54) SYSTEM AND METHOD FOR PREVENTING COLLAPSE OF A GREEN HOUSE BY SNOW LOAD

(71) Applicant: INDUSTRIAL COOPERATION FOUNDATION CHONBUK NATIONAL UNIVERSITY, Jeonju-si (KR)

(72) Inventor: Jeong Ki PARK, Jeonju-si (KR)

(21) Appl. No.: 15/633,749

(22) Filed: Jun. 26, 2017

(30) Foreign Application Priority Data
Nov. 18, 2016 (KR) 10-2016-0153954

(51) Int. Cl. E04D 13/10; G01S 13/88; G05B 15/02; A01G 9/14

(52) U.S. Cl. CPC E04D 13/103; E04D 13/106; A01G 9/1407; G05B 15/02; G01S 13/88

(57) ABSTRACT

The present invention relates to a system and method for preventing collapse of a green house by snow load, more particularly, relates to preventing collapsing of the green house due to unexpectedly occurrable heavy snowfall, by calculating the snow load per unit area based on the amount of snow deposited on the green house roofs measured by radar (radio detection and ranging) sensors, by analyzing whether the green house can withstand snow loads by comparing the calculated snow load with structural information of the green house, and by driving a snow removing device according to the result of the analysis, in which the snow removing device comprises a heater, a blower, a vibrator, or the combinations thereof installed in the green house or providing an emergency message to the user terminal held by an administrator.

### BACKGROUND

The present invention relates to a technology for preventing collapse of a green house, more particularly, relates to a system and a method for preventing collapse of the green house by snallfall lead weight for protecting collapse accident of the green house due to unexpectedly occurrable heavy snowfall, by calculating the snow load per unit area based on the amount of snow deposited on the green house roofs measured by radar (radio detection and ranging) sensors, by analyzing whether the green house can withstand snow loads by comparing the calculated snow load with structural information of the green house, and by driving a snow removing device according to the result of the analysis, in which the snow removing device comprises a heater, a blower, a vibrator, or the combinations thereof installed in the green house or providing an emergency message to the user terminal held by an administrator.

The present invention was supported by both the MSIP (Ministry of Science, ICT and Future Planning), Korea, under the ITRC (Information Technology Research Center) support program (1711035204 (IITP-2017-2015-0-00378)) supervised by the IITP (Institute for Information & communication Technology Promotion).

In general, a vinyl house is a greenhouse covered with vinyl film for cultivation of vegetables, flowers, and forced cultivation for kinds of fruits or for the cultivation of tropical plants.

The vinyl house refers to a structure in which plurality of transversely bent ribs are installed at regular intervals and then fixed to each other to form a frame, wherein the frame is covered with a vinyl film.

These vinyl houses are widely used for raising income of farming and fishing villages in winter, but in recent years, serious damage has been caused by heavy snow due to extreme unusual weather phenomena.

In other words, in case that the snow piled up on the roof of the green house can not slip or melt due to the snowfall in winter, the green house is under a large load and thus the frame fails to sustain and collapses, and thus both the green house itself and the cultivated crops are destroyed. Moreover, if the green house collapses, there was a serious problem that would ruin long-lasting farming efforts.

As such, in order to prevent the collapse of the green houses by heavy snowfall, people have tried to prevent collapse by carrying out work such as sweeping snow piled up on the roof of a green house directly in the past, but it has not been very effective to do the work in large-scale facilities due to the shortage of workers.

Moreover, conventionally people used a technique of blowing snow or melting snow on the roof of green house by providing a device equipping with a separate snow removal device that generates blowing, heat, and vibration in the green house, and by driving the device if the snowfall weight load exceeds the reference value. However, the mass or volume of snow accumulated in a certain area should be measured in order to measure the snow load. So, there is a need for additional flat plate facilities of a certain size or more in addition to a weight sensor. Thus, the initial installation cost was high and there were many restrictions on the installation position of the measuring device because the facility for measuring snow load should be horizontal level with the green house roof surface. In this regards, there is a problem that it is very difficult to arbitrarily change or modify the measurement position once the snow load measuring device is installed.

Therefore, the present invention provides a method to prevent collapse of a green house by heavy snow as follows. The snowfall weight load measured by the radar sensor is calculated with software. The calculated snowfall weight load is compared with the those for the previously stored structure information. The snow removal equipment installed in the green house is drived according to whether the green house can withstand the snowfall weight load, or an emergency message is provided to a user terminal.

Hereinafter, brief description of the prior art in the technical field of the present invention is provided, and then the technical features the present invention is intended to be differentiated from the prior art will be described.

Firstly, Korean patent registration No. 1640399 (2016 Jul. 18.) relates to a green house protection system and method that can safely protect the green houses from natural disasters such as heavy snow, strong winds, and high temperature phenomenon, thereby promoting crop growth.

According to the above prior art, heat and wind inside and outside the green house are generated if it is detected that the weight and temperature are higher than thoses of the predetermined values at the time of heavy snow and high temperature. Thus the present invention provides the effect of protecting the crops safely by preventing the collapse of the green house during heavy snowfall. In these respects, the above prior art is somehow similar with the present invention in terms of preventing the collapse of the green house based on the weight information of the snow.

However, the present invention provides the technical configuration that the snowfall amount measured by the radar sensor is processed by software to calculate the snowfall weight load, and the calculated snowfall weight load is compared with the previously determined and stored snowfall weight load for the structure information to prevent collapse of the green house. On the other hands, the above prior art discloses the technical configuration to directly measure the weight of snow by using weight sensor and generate heat or wind based on measured information. Thereby it is obvious to a person skilled in the art to exist the difference between the present invention and the above prior art.

Moreover, Korean patent registration No. 1526272 (2015 Jun. 12.) relates to a snowfall warning system to prevent disasters in advance, which provides an alarm signal as roofs of buildings, green houses or other structures accumulate heavy snow in access of allowable snowfall weight or allowable snowfall amount, thereby, preventing disasters in advance.

This prior art detects that the snowfall amount of the roof exceeds the allowable load through the snow board and the load meter having the predetermined area, and provides an alarm signal through the alarm generator, and thus providing rapid evacuation or snow removal and then the effect of preventing large accidents such as building collapse caused by wetting snow. In these respects, this prior art has some similarities with the present invention in that it can prevent collapse by warning when the snowfall of the roof exceeds the allowable load.

However, the present invention provides the technical configuration that it is not necessary to use a snowboard or a load meter to check the snow load on the roof of a green house as is necessary in the prior art, the snow load is processed by the software according to the snowfall measured simply by using the radar signal, and then the processed snow load is compared with that for the green house structure information to prevent collapse of the green house. Thereby it can be confirmed that the difference of technical configuration between the present invention and the prior art is clear.

Moreover, Korean Utility Registration No. 0423353 (2006 Aug. 7) relates to a snow cover for a green house, which can effectively remove the accumulated snow of the green house in the winter.

The above prior art is similar to the present invention in some parts in that the prior art can prevent the snow from accumulating on the roof of the green house when the snow is snowing in the winter, thus preventing the collapse of the green house, it can reduce the damage to the farmers, and thus providing effects that improve the quality of life.

However, the present invention provides the technical configuration of preventing collapse of the green house in which the snow load is processed by the software according to the snowfall measured simply by using the radar signal and then the processed snow load is compared with that for the structure information of the green house. In other words, the prior art discloses the technical configuration generating vibrations depending on the weight load and the equilibrium of the snow accumulated on the roof of green houses. Thus, the present invention and the prior art have a difference in technical construction.

That is, the above mentioned prior arts suggest the technical configurations measuring the weight of snow piled on the roof of a green house using a weight sensor or snowboard, if the measured weight of snow exceeds the allowable load, generating heat and wind, or vibrations inside and outside the green house, performing warning, and thus preventing collapse of the green house. On the other hands, the present invention provides the technical configurations measuring the snow amount accumulated on the roof through the radar sensor which can be easily installed while varying the mounting positions according to the usage environment of the green house, and then calculating the accumulated snow weight load by software processing, then analyzing by comparing the processed snow weight with that for the structural information of the green house, if there is a risk of collapse, driving the snow removal system or providing a warning information to a user. Therefore, the present invention and the prior art are technically distinct.

In addition, the present invention is characterized in that since the snow load measured by the radar sensor is processed by software to calculate the snow load, there is no restriction on the installation location unlike the above-mentioned prior arts where there is a restriction on the installation position of the measuring device to measure the mass or volume of snow accumulated in a certain area of the green house, and it is possible to arbitrarily change the position of a measuring device according to the green house installation environment and use the measuring device.

### SUMMARY

The present invention is composed for resolving the above problems, and it is objective for the present invention to provide a system and method for preventing collapse of a green house by snow load, by comparing the snow load calculated based on the snow amount accumulated on the roof of the green house and the predetermined snow load according to the structural information of the green house and accurately analyzing whether green houses can withstand the snow load.

In addition, it is another objective for the present invention to provide a system and method for preventing collapse of a green house by snow load, by calculating the snow load per unit area based on the amount of snow piled up on the roof of the green house measured by the radar sensors, if there is a risk of collapse, by driving a snow removal device including a heating device, a blowing device, a vibration device, or a combination thereof installed in a green house, or providing an urgent message to a user terminal.

In addition, it is another objective for the present invention to provide a system and method for preventing collapse of a green house by snow load, in which a collapse prevention device is connected with at least one or more green houses provided in a certain area via network, calculates snow loads based on the measured snowfall loads of each green house, and analyzes whether the green house is collapsed.

A system for preventing collapse of a green house by snowfall load in accordance with an embodiment of the present invention comprises a snowfall load amount analyzer for comparing the measured data measured by a measuring device installed in the green house with the stored reference data and identifying the amount of snow piled on the roof of the green house, a snowfall load weight calculator for calculating a snow weight per unit area based on the snow piled on the roof of the green house identified by the snowfall load amount analyzer, and a collapse risk minotor for comparing the snowfall load weight calculated in the snowfall load weight calculator with the previously stored structural weight information for the green house and monitoring whether or not the green house can withstand the snowfall load based on the comparing result.

The measured data are the data on the intensity, speed, wavelength of radio waves, or the combinations thereof of radio waves that are changed by the medium of vinyl and snow, and the reference data are the information data on the vinyl comprising ingredient, material, thickness or the combinations thereof and the propagation characteristics of the radio waves measured in advance according to the snowfall amount, and constructed as a table.

The system for preventing collapse of green house by snowfall load further comprises: a snow removal device driving controller for controlling driving of a snow removing device comprising a heater, a blower, a vibrator, or the combinations thereof installed in the green house on the basis of the result of the collapse risk judgment according to the monitoring result of the collapse risk monitor, and the snow removal device driving controller controls the operation time or intensity of the snow removal device according to each step of the risk of collapse.

The system for preventing collapse of the green house further comprises: an information provider transmitting information data predetermined user terminal via network, in which the information data comprises step-by-step warning information, countermeasures, or the combinations thereof, relating to snowfall amount and snowfall load weight piled on the roof of the green house, based on the decision result of the collapse risk according to the monitoring of the collapse risk monitor, and a display for displaying the information data comprises step-by-step warning information, countermeasures, or the combinations thereof, relating to snowfall amount and snowfall load weight piled on the roof of the green house generated by the information provider.

The measuring device is a radar sensor which a transmitter and a receiver are seperated, and the transmitter and the receiver are separately installed inside or outside the green house.

The measuring device comprises a measuring module installed inside or outside the green house as a radar sensor integrated with transmitting and receiving functions, and a reflector installed at a position corresponding to a radio wave output direction of the measuring module and reflecting a radio wave outputted from the measuring module.

The reflector is installed outside or inside the roof of the green house, which is a position corresponding to a position of the measuring module installed inside or outside the green house, and one or more of which the reflector is installed at intervals in the green house.

A method for preventing collapse of a green house by snowfall load in accordance with another embodiment of the present invention comprises: analyzing a snowfall load amount by comparing the measured data measured by a measuring device installed in the green house with the stored reference data and identifying the amount of snow piled on the roof of the green house in an apparatus for preventing collapse of the green house; calculating a snowfall load weight by calculating a snow weight per unit area based on the snow piled on the roof of the green house identified by the snowfall load amount analyzer in the apparatus for preventing collapse of the green house; and monitoring a collapse risk by comparing the snowfall load weight calculated in the snowfall load weight calculator with the previously stored structural weight information for the green house and monitoring whether or not the green house can withstand the snowfall load based on the comparing result in the apparatus for preventing collapse of the green house.

The measured data are the data on the intensity, speed, wavelength of radio waves, or the combinations thereof of radio waves that are changed by the medium of vinyl and snow, and the reference data are the information data on the vinyl comprising ingredient, material, thickness or the combinations thereof and the propagation characteristics of the radio waves measured in advance according to the snowfall amount, and constructed as a table.

The method for preventing collapse of green house by snowfall load further comprises: driving a snow removal device by controlling driving of a snow removing device comprising a heater, a blower, a vibrator, or the combinations thereof installed in the green house on the basis of the result of the collapse risk judgment according to the monitoring result of the collapse risk monitoring, and driving the snow removal device is performing that the snow removal device driving controller controls the operation time or intensity of the snow removal device according to each step of the risk of collapse.

The method for preventing collapse of a green house by snowfall load further comprises: providing an information by transmitting information data predetermined user terminal via network, in which the information data comprises step-by-step warning information, countermeasures, or the combinations thereof, relating to snowfall amount and snowfall load weight piled on the roof of the green house, based on the decision result of the collapse risk according to the monitoring of the collapse risk monitor in the apparatus for preventing collapse of the green house; and displaying the information data comprises step-by-step warning information, countermeasures, or the combinations thereof, relating to snowfall amount and snowfall load weight piled on the roof of the green house generated by the information provider in the apparatus for preventing collapse of the green house.

Wherein analyzing a snowfall load amount identifies the snowfall load amount by comparing the measured data in the measuring device with the reference data in which the measuring device is a radar sensor which a transmitter and a receiver are seperated, and the transmitter and the receiver are separately installed inside or outside the green house.

Wherein analyzing a snowfall load amount identifies the snowfall load amount by comparing the measured data in the measuring device with the reference data, in which the measuring device comprises a measuring module installed inside or outside the green house as a radar sensor integrated with transmitting and receiving functions, and a reflector installed at a position corresponding to a radio wave output direction of the measuring module and reflecting a radio wave outputted from the measuring module, the reflector is installed outside or inside the roof of the green house, which is a position corresponding to a position of the measuring module installed inside or outside the green house, and one or more of which the reflector is installed at intervals in the green house.

As described above, according to the present invention which relates to a green house collapse preventing system and the method by the snow load, the system and method provide calculating the snow load on the basis of snow amount measured by using radar sensor, analyzing whether or not the green house can withstand based on the calculated snow load, and then if there is a risk of collapse, driving a snow removal device including a heating device, a blower, a vibration device, or a combination thereof, which are installed in a green house, or sending an emergency message to a user (administrator) terminal, thereby it is effective to prevent a collapse of a green house due to heavy snow that may occur unexpectedly and reduce the cost of economic loss caused by the collapse of the green house.

Moreover, since a single collapse prevention device performs the calculation of the snow load according to the snowfall measurement for each green house in a certain area connected through network, the analysis for the collapse of the structure based on the calculated snow load, and the provision for countermeasures related to snow removal based on the analysis results, it is effective to flexibly construct a green house collapse prevention system according to the location and structure of the green house, and It is effective to construct the system at a relatively low cost and to easily perform the maintenance of the measuring apparatus and the various snow removing apparatus provided in the green house.

Moreover, since the system according to the present invention measures snowfall amount using only small radar sensors and reflectors and calculates the snow load by software processing the measured snowfall amount, it is effectively possible to reduce the installation cost because a separate plate-like facility used for measuring the snow load is not necessary as in the conventional art, and it is also effectively possible to variously change the installing position of the snowfall amount measuring apparatus according to the environments because there is no need to be horizontal with the roof surface of the green house as in the prior art.

### BRIEF DESCRIPTION OF THE DRAWINGS

For more complete understanding of this disclosure, reference is now made to the following brief description, taken in connection with the accompanying drawings and detailed description.

FIG. 1 is a conceptual diagram for explaining processes of preventing a green house collapse by the snow load in accordance with the present invention.

FIG. 2 is a drawing for showing briefly the configuration of a system for preventing a green house collapse by the snow load in accordance with an embodiment of the present invention.

FIG. 3 to FIG. 5 are drawings for showing in details the configurations according to each embodiment for a measuring apparatus shown in FIG. 2.

FIG. 6 is a drawing for showing briefly the configuration of a collapse preventing apparatus shown in FIG. 2.

FIG. 7 is a drawing for explaining the roof slope coefficient on calculating the snow load in the snow load calculator in FIG. 6.

FIG. 8 is a flowchart for describing in details operational processes of a method for preventing a green house collapse by the snow load in accordance with an embodiment of the present invention.

### DETAILED DESCRIPTION

Hereinafter, preferred embodiments of the present invention, a system and method for preventing collapse of a green house (i.e., vinyl house) by snow, are explained in detail with reference to accompanying figures. The same reference sign in each figure represents the same component. In addition, the specific structural or functional explanation for embodiments of the present invention is used for exemplifying the embodiments only and all the terms including technical and scientific terms used in this document have the same meaning, unless defined differently, as the meaning generally understood by those who have ordinary knowledge in the technical area the present invention belongs to. The terms defined in commonly used dictionaries are interpreted as the same meaning coincident with the contextual meaning in the related technology and if not explicitly defined in this specification, it is preferable not to be interpreted as too ideal or perfunctory meaning.

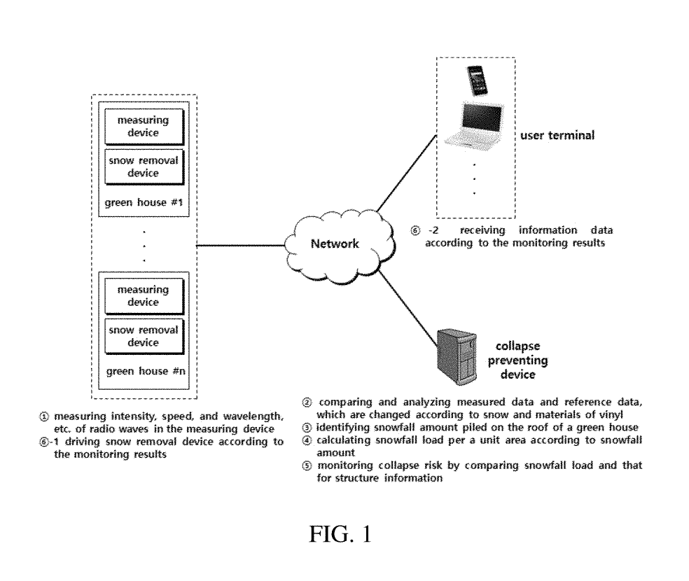

FIG. 1 is a conceptual diagram for explaining processes of preventing a green house collapse by the snow load in accordance with the present invention.

As shown in FIG. 1, a measuring device for measuring snowfall amount accumulated on the roof of the green house is installed at a predetermined position inside or outside the green house. At this time, the measuring device is electrically connected to the collapse preventing device through a network.

The measuring device uses a radar sensor that uses radio waves that can pass through materials such as vinyl and snow. The rader sensor is used in the present invention because the conventional laser sensor used mainly for measuring the snowfall amount can not normally measure the thickness of the snow piled on the roof of the vinyl house due to the laser passing through the plastic as it passes through the plastic or absorbed or reflected by the laser by the obstructed objects or obstacles.

The measuring device uses a radar sensor with separate transmission and reception functions. The radar sensor of the transmission function is installed outside the roof of the vinyl house and the radar sensor of the reception function is installed inside the roof of the vinyl house, or conversely, the radar sensor of the transmission function can be installed inside the roof of the vinyl house, and the radar sensor of the reception function can be installed outside the roof of the vinyl house

In addition, the measuring device can be installed at a predetermined position inside or outside the vinyl house using a radar sensor in which the transmitting and receiving functions are integrated in addition to the radar sensor of the detachable structure as described above. In this case of using the integrated radar sensor, the measuring device is additionally provided with a separate reflector at a position corresponding to the direction of the radio wave output. That is, the radio wave output from the radar sensor is reflected by the reflector. When the integrated type of radar sensor is installed outside the vinyl house roof, the reflector is installed inside the vinyl house roof. And when the integrated type of radar sensor is installed inside the vinyl house roof, the reflector is installed outside the vinyl house roof.

Moreover, together with the measuring device, a snow removal device including a heating device, a blowing device, a vibration device, or the combinations thereof may be additionally provided at a predetermined position of the vinyl house. The snow removal device is driven by control of a collapse preventing device and performs functions to dissolve snow piled on the roof of a vinyl house with heat, to blow it with wind or to generate vibration.

The collapse preventing device is connected with the measuring device and a snow removal device installed in at least one or more vinyl houses, and identifies the thickness of the snow piled on the vinyl house roof (ie, snowfall amount) based on the measured data including speed, wavelength, frequency shift, phase change, or the combinations thereof, which are changed by a medium such as vinyl or snow transmitted from the measuring device composed of a radar sensor.

After calculating the snow load per unit area based on the snowfall amount based on the identified snowfall amount, the calculated snow load is compared with that for the structure information of the vinyl house, and whether the vinyl house can withstand the current snow load is monitored, if it is determined that there is a risk of collapse as a result of the monitoring, the snow removal device including the heating device, the blowing device, the vibration device, or the combinations thereof installed in the vinyl house is driven, or an emergency message is provided to a user terminal owned by administrator, thereby making response to heavy snowfall and so as to prevent the collapse of the vinyl house.

At this time, the emergency message can be provided in the form of a text message or an electronic mail as information data related to the current snowfall amount, snow load, collapse risk level (for example, attention, attention, warning, etc.).

Hereinafter, the process of preventing the vinyl house collapse by the snow load is described in detail as follows.

First, when the snowfall measuring time for measuring the thickness of the snow piled on the roof of the vinyl house is reached, the measuring device including the radar sensor is driven to perform measurements comprising the intensity, speed, wavelength or the combinations thereof of radio waves, which are changed by a medium such as vinyl, snow, and the like. That is, in the case of a measuring device in which a transmitter and a receiver are separated, a radar signal output from a transmitter is received by a receiver, and in the case of a measuring device in which the transmitting and receiving functions are integrated, the radar signal output from the measuring module is reflected by a reflector provided at a position corresponding to the direction of the radio wave output, and thus the measurements of the radio wave are performed (\textcircled{1}).

When measurements including the intensity, speed, wavelength, or the combinations thereof of radio wave which are changed by the medium such as vinyl, snow or the like are performed in the measuring device, the measurements data are transmitted over network to the collapse preventing device, and then the collapse preventing device compares and analyzes the measurements data transmitted from the measuring device and the stored reference data (\textcircled{2}). Wherein, the reference data includes the propagation characteristics of radio waves according to the vinyl information and the snowfall amount and the vinyl information is information including a component, a material, a thickness, or the combinations thereof of vinyl, and the propagation characteristics of radio waves is information including intensity, speed, wavelength, or the combinations thereof of radio waves according to the snowfall amount.

Then the collapse preventing device identifies thickness of snow piled on the roof of the vinyl house based on the comparison between the measured data measured by the measuring device and the previously stored reference data (\textcircled{3}).

Thereafter, the collapse preventing device calculates a snow load per unit area based on the detected snowfall amount (\textcircled{4}), compares the calculated snow load with that for the structure information of the vinyl house, and monitors whether the vinyl house can withstand the snow load (\textcircled{5}). At this time, it is desirable to perform monitoring by dividing the risk of collapse of the vinyl house according to the snow load applied to the vinyl house by various stages such as attention, caution, and warning.

If it is determined that the vinyl house is likely to collapse due to the snow load, the collapse preventing device controls the driving of the snow removing device including a heating device, a blowing device, a vibration device, or the combinations thereof installed in the green house, and thereby preventing a vinyl house from being collapsed (\textcircled{6}-1). Or the collapse preventing device transmits information data to a user terminal as an emergency message, wherein the information data relate to current snowfall and snow load, collapse risk level (for example, attention, caution, warning, etc.) and information related to countermeasure, and thereby enabling a user to immediately response to heavy snow conditions (\textcircled{6}-2). At this time, the information data may be provided to the user terminal and displayed through a display provided in the collapse preventing device.

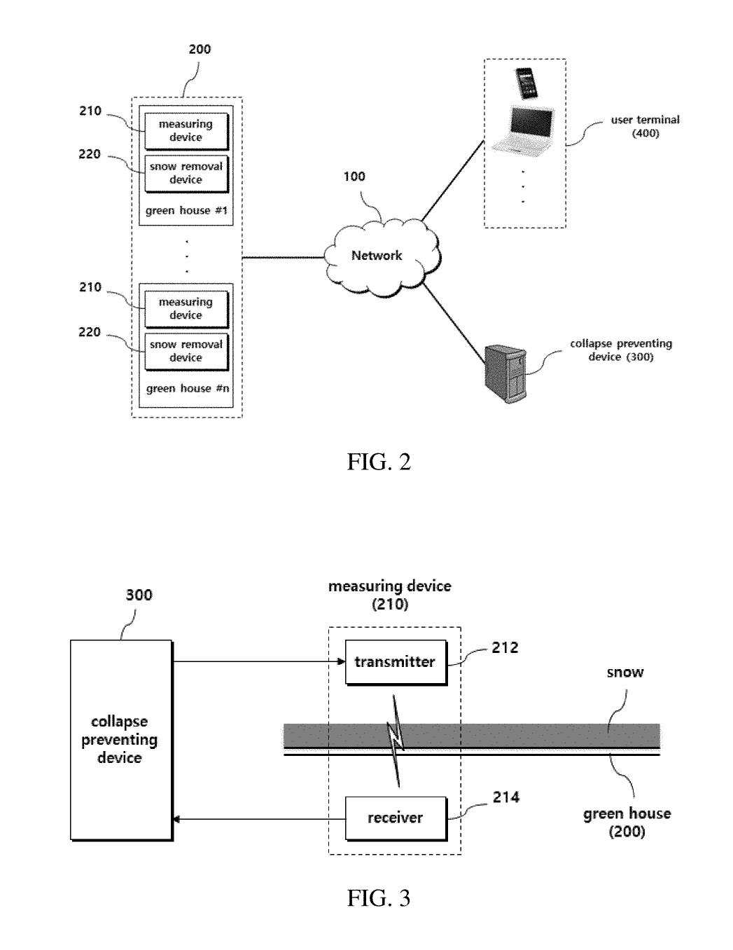

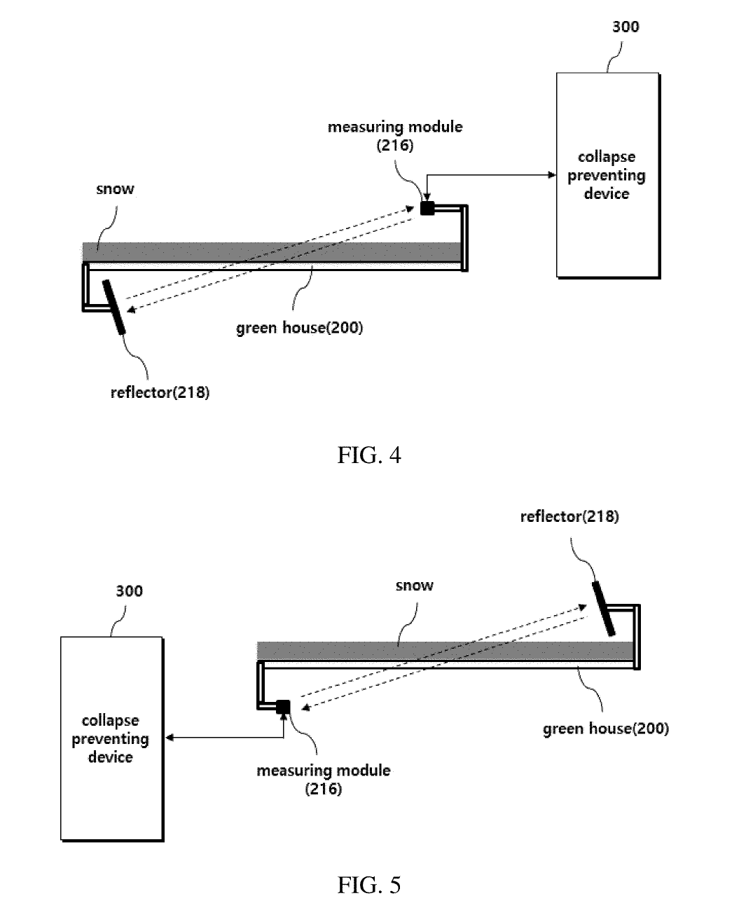

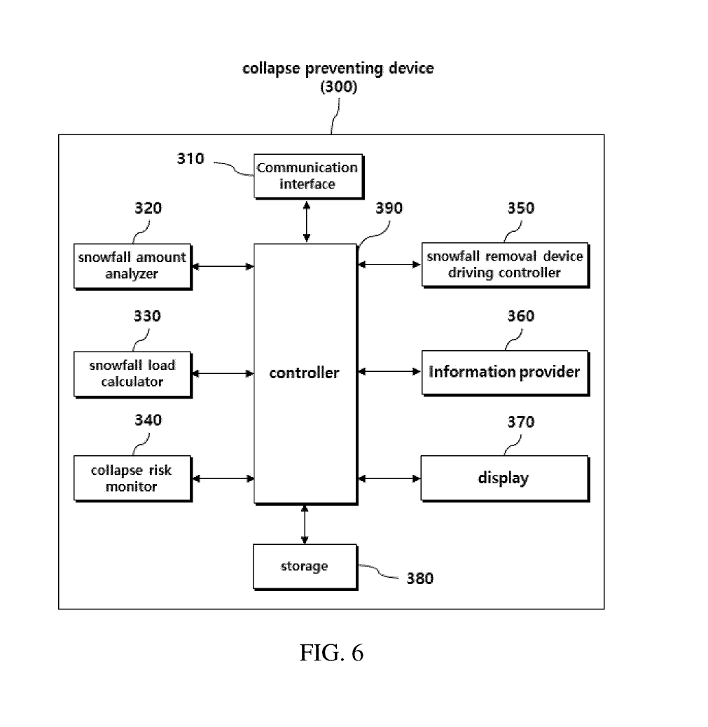

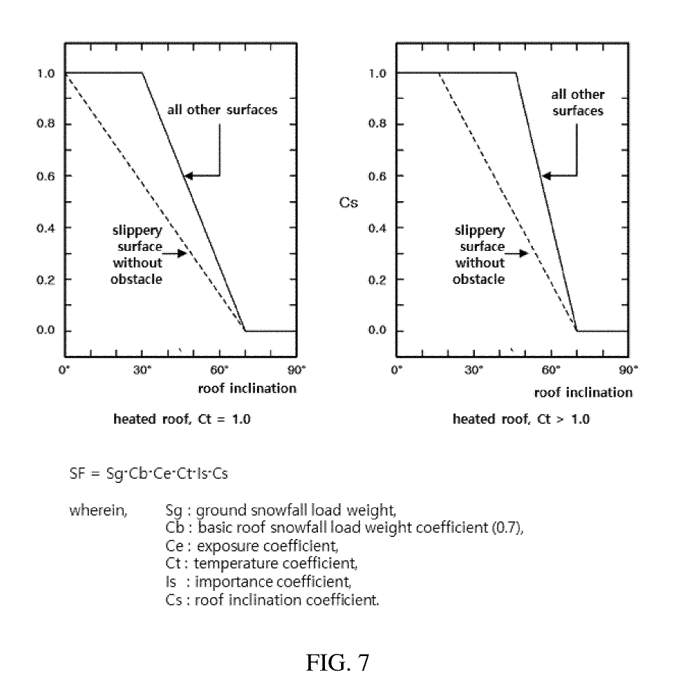

As explained above, FIG. 2 is a drawing for showing briefly the configuration of a system for preventing a green house collapse by the snow load in accordance with an embodiment of the present invention, and FIG. 3 to FIG. 5 are drawings for showing in details the configurations according to each embodiment for a measuring apparatus shown in FIG. 2, and FIG. 6 is a drawing for showing briefly the configuration of a collapse preventing apparatus shown in FIG. 2, and FIG. 7 is a drawing for explaining the roof slope coefficient on calculating the snow load in the snow load calculator in FIG. 6.

As shown in FIG. 2, the system for preventing a green house collapse by the snow load in accordance with an embodiment of the present invention comprises network 100, a vinyl house (or a green house) 200, a collapse preventing device 300, and a user terminal 400.

The network 100 is a variety of currently known communication networks including wired/wireless Internet, bluetooth, Zigbee, Wi-Fi and the like. The network 100 connects the communication lines between the measuring device 210 and the snow removal device 220 installed in the green house 200, the collapse preventing device 300 and the collapse preventing device 300 and the user terminal 400, The data communication related to the operation or information of the device for preventing the house collapse is performed between the devices.

The green house 200 is provided with a measuring device 210 for measuring snowfall amount accumulated on a roof and a snow removing device 220 including a heating device, a blowing device, a vibration device, or the combinations thereof.

The collapse preventing device 300 is communicatively connected to the measuring device 210 and the snow removal device 220 installed in the green house 200 through the network 100, and identifies the thickness of the snow piled on the roof of the green house 200 by comparing the measured data transmitted from the measuring device 210 with the previously stored reference data. Wherein the measurement data is data on the intensity, speed, wavelength, or the combinations thereof for radio waves that are changed by a medium such as vinyl, snow or the like, and the reference data is tabular data obtained by preliminarily measuring vinyl information including ingredient, quality, thickness, or the combinations thereof, and propagation characteristics according to respective snowfall amounts.

The collapse preventing device 300 calculates a snow load per unit area based on the amount of snow piled on the roof of the green house 200, and monitors whether or not the vinyl house can withstand the snow load by comparing the calculated snow load with that for the structure information of the previously stored vinyl house, and drives, if it is determined that there is a risk of collapse, the snow removing device 220 including a heating device, a blowing device, a vibration device, or the combinations thereof installed in the green house 200 based on the monitoring result, or provides an emergency message to a user terminal 400 owned by administrator.

The user terminal 400 is a device such as a computer, a smart phone, a tablet PC, a notebook PC or the like possessed by a user who operates or manages the green house 200. The user terminal 400 can access information data including the snowfall amount accumulated on the roof of the green house 200, snow load, step-by-step warning information regarding the risk of collapse, countermeasures, or the combinations thereof, which are transmitted from the collapse prevention device 300 through the network 100.

Moreover, the measuring device 210 installed in the vinyl house 200 measures the intensity, speed, wavelength, or the combinations thereof of the radio waves that are changed by the medium including the snow piled on the vinyl and vinyl house roofs, and outputs measurement data to the collapse prevention device 300 through the network 100.

The measuring device 210, as shown in FIG. 3, can be configured as a radar sensor separated by a transmitter 212 and a receiver 214 (the present invention explains to use a radar sensor as an example, however, the present invention is not limited to the radar sensor, but can use any sensor that can be used in a vinyl house environment), and in this case, the radar sensor can be separately installed inside or outside the green house 200. That is, the transmitter 212 is installed outside the roof of the green house 200, and the receiver 214 is installed inside the roof of the green house 200. Moreover, although not shown in figures, contrary to the installation method of FIG. 3, the transmitter 212 may be installed inside the roof of the green house 200 and the receiver 214 may be installed outside the roof of the green house 200.

Likewise, if the measuring device 210 is configured as a separate type, since the radar signal output from the transmitter can be received and processed by the receiver, there is no need to use a high-power radar signal because the radar signal does not need to travel back and forth between the measuring device and the reflector. However, the radar signal needs to travel back and forth between the measuring device and the reflector in the measuring device that integrate transmit and receive functions.

As such, if the measuring device 210 is configured as a separate type, since the radar signal output from the transmitter is received and processed by the receiver, there is no need for the radar signal to reciprocate the distance between the measuring device and the reflector like the measuring device in which the transmitting and receiving functions are integrated, and thereby not necessary to use high power radar signals. As a result, it is possible to reduce the output power and number of radar signals which have the ability to output thousands of signals with different phases, thereby reducing power consumption, and since the measuring device is divided into a transmitter and a receiver, it is possible to take advantage to simplify the configuration of the measuring device and simplify the design of the measuring device.

In addition, unlike FIG. 3, in which the transmitter 212 and the receiver 214 are separated from each other, the measuring device 210 comprises a measuring module 216 in which transmission and reception functions and a reflector 218 are integrated as shown in FIGS. 4 and 5.

The measuring module 216 is a radar sensor that integrates transmission and reception functions, is installed outside or inside the vinyl house 200, and receives the radio wave reflected by the reflection plate 218 provided at the position corresponding to the radio wave output direction, and thus the measuring device 216 measures strength, velocity, wavelength, or the combinations thereof for radio waves that are changed by the medium including the snow piled up on the vinyl and vinyl house roof, and outputs the measured data to the collapse prevention device 300 through the network 100.

The reflection plate 218 is installed outside or inside the roof of the greenhouse 200, in which the position corresponds to the position of the measuring module 216 installed inside or outside the green house 200. That is, as shown in FIG. 4, if the integrated measuring module 216 is installed by connecting with a support fixture outside the vinyl house roof, the reflector 218 is installed inside the roof of the green house 20. And as shown in FIG. 5, if the integrated measuring module 216 is installed inside the roof of the plastic house 200, the reflection plate 218 is installed outside the roof of the vinyl house 200.

The reflector (i.e., reflection plate) 218 can be installed on the outside or inside of the roof of the green house 200 with an interval therebetween. That is, when it is determined that the length and size of the green house 200 are large and the measurements of snowfall amount are required at various points, the number of the reflectors 218 can be increased. At this time, the measurement module 216 can be configured to have the same number as the number of the reflectors 218, or a driver capable of moving the propagation direction output from the measurement module 216 is additionally provided, thereby it can be configured to measure snowfall amount at various points with a single measurement module.

The reflector 218 is preferably formed of metal such as iron or aluminum that can easily reflect the radio wave, but it is not limited thereto, and any material can be used as long as it is a material excellent in reflection characteristics of radio waves.

It is preferable that the measurement module 216 and the reflector 218 are mounted on the outside or inside of the roof of the green house 200 so as to be spaced from the inside or outside of the roof by a predetermined distance.

As shown in FIG. 4 and FIG. 5, the reflector 218 can be installed in a vertical shape if there is no problem in the measurement of the snowfall amount, other than a method of installing the reflector 218 at a predetermined angle.

As shown in FIG. 6, the collapse preventing device 300 comprises a communication interface 310, a snowfall amount analyzer 320, a snow load calculator 330, a collapse risk monitor 340, a snow removal device driving controller 350, an information provider 360, a display 370, a storage 380, a controller 390, and the like.

The communication interface 310 transmits the measured data to the controller 390, in which the measured data are obtained by measuring the intensity, speed, wavelength, or the combinations thereof of radio waves changed by the medium including the snow piled on the vinyl and vinyl house roof received from the measuring device 210 through the network 100.

In addition, the communication interface 310 outputs control signals for driving the snow removal device 220 to the snow removal device 220 of the corresponding green house 200 based on the control of the snowfall removal device driving controller 350, and transmits information data to the user terminal 400 through network 100. Wherein the information data includes stepwise warning information, countermeasures, or the combinations thereof which are related to snowfall amount accumulated on the roof of the vinyl house, snowfall load, and collapse risk generated by the information provider 360.

The snowfall amount analyzer 320 compares the measurement data measured by the measuring device 210 installed in each green house 200 transmitted through the communication interface 310 and the reference data previously stored in the storage 380, identifies the width of snowfall (i.e., snowfall amount) accumulated on the roof of the green house 200, and then outputs the confirmed snowfall amount information to the controller 390.

The snow load calculator 330 calculates the snow load per a unit area on the basis of the snow amount accumulated on the roof of the green house 200 identified by the snowfall amount analyzer 320, and then outputs the calculated snow load data per unit area to the controller 390.

The snow load calculator 330 calculates the snow load of the roof according to the following equation 1.

Sf=Sg*Cb*Ce*Ct*Is*Cs [Equation 1]

Wherein, Sg is ground snowfall load weight, Cb is basic roof snowfall load weight coefficient (0.7), Ce is exposure coefficient, Ct is temperature coefficient, Is is importance coefficient, and Cs is roof slope coefficient.

The above equation 1 is excerpted from the architectural design standard published in the Notice No. 2005-81 of Ministry of Construction & Transportation of Korea dated Apr. 6, 2005, and equation 1 is informative and other known mathematical expressions or methods may also be used depending on the system implementation environments.

At this time, the ground snowfall load weight is set differently according to the vertical deepest snow depth in accordance with each region. For example, the ground snowfall load weight for Seoul, Suwon, Chuncheon, Seosan, Cheongju, Daejeon, Chukbyeol, Pohang, Gunsan, Daegu, Jeonju, Ulsan, Gwangju, Busan, Tongyeong, Mokpo, Yeosu, Jeju, Seogwipo, Jinju, Wooljin and Echun in Korea is 50. The ground snowfall load weight for Incheon is 80, the ground snowfall load weight for Sokcho is 200, the ground snowfall load weight for Gangneung is 300, and, the ground snowfall load weight for Ulleungdo and Daegwallyeong is 700.

In addition, the exposure coefficient is set to a different value depending on the surrounding environment. For example, strong windy areas with roofs exposed to the winds without any windshields due to the surrounding environment such as terrain, high structure, tree, etc are set to 0.8, strong windy areas with a slight windshield are set to 0.9, locations where the roof load can not be expected to be reduced because the wind can not remove snow due to terrain, high structure or some nearby trees are set to 1.0, windy areas affected by wind and areas with a windshield on the roof by terrain and high structures or some trees are set to 1.1, and the roofs located between dense conifers as a dense forest area with little wind impact are set to 1.2.

In addition, the temperature coefficient is set to 1.0 for the heating structure (snow load control structure) and 1.2 for the non-heating structure (snow load noncontrol structure).

In addition, the importance coefficient is set differently according to the use and scale of the building. For example, it is set to 1.2 for case of importance (special), such as dangerous materials storage and treatment facilities with a floor area of 1,000 square meters or more, general hospitals, hospital broadcast stations, telegraph offices, power stations, fire stations, public service facilities and elderly facilities. It is set to 1.1 for the case of importance (1), such as exhibition facilities, sports facilities, transport facilities, exhibition facilities and sales facilities, accommodations with 5 floors or more, officetels, dormitories and apartments with a floor area of 5,000 square meters. It is set to 1.0 for the case of importance (2), which is a building whose importance does not correspond to (special), (1) and (3), and it is set to 0.8 for the case of hypothetical buildings, farmhouse buildings and small warehouses (3).

In addition, the roof slope coefficient, as shown in FIG. 7, are differently applied for each the heated roof that temperature coefficient (Ct) is 1.0 and the heated roof that temperature coefficient (Ct) is greater than 1.0, respectively.

The collapse risk monitor 340 compares the snow load calculated in the snow load calculator 330 with the snow load according to the structure information of the green house stored in the storage 380, monitors whether the green house is able to withstand the snow load, and decides the collapse risk.

The snow removal device driving controller 350 controls driving of the snow removal device 220 including the heating device, the air blowing device, the vibration device, or combinations thereof installed in the green house 200, in which the control is performed based on the results of the collapse risk assessment monitored by the collapse risk monitor 340.

At this time, the snow remover driving controller 350 can control the operation time and operation intensity of the snow removal device 220 according to each step when the collapse risk monitor 340 determines the collapse risk in multiple stages.

Based on the controls of the controller 390, the information provider 360 generates information data including the snow amount and snow load deposited on the roof of the green house 200, stepwise warning information with respect to collapse risk, countermeasures, or combinations thereof, which are based on the collapse risk determinant result according to monitoring of the collapse risk monitor 340. The information provider 360 transmits the information data to the predetermined user terminal 400 through network 100.

The display 370 can include a generally known LCD or LED, outputs information data including snowfall amount and snowfall load accumulated on the roof of the green house generated by the information provider 360, stepwise warning information relating to risk of collapse, countermeasures, or combinations thereof.

The storage 380 stores the execution program used by the collapse preventing device 300, and stores the reference data for identifying the thickness of the snow piled on the roof of the green house, and stores the structural information of each green house to be monitored.

In addition, the storage 380 stores the information (for example, telephone number, e-mail address, etc.) of each user terminal 400 which receives information data including snowfall amount and snowfall load accumulated on the roof of the green house 200, stepwise warning information relating to risk of collapse, countermeasures, or combinations thereof.

The controller 390 controls receiving of measured data from the measuring data 210 installed at each green house 200, transmitting of control signals for driving each kind of snow removal device installed at each green house, and transmitting information data relating to risk of collapse for a green house by snow load via communication interface 310, and identifying snowfall amount through the comparing measurement data transmitted from the measuring device 210 with reference data via the snowfall amount analyzer 320, and calculating of snow load per unit area based on the current snowfall amount in the snow load calculator 330.

In addition, the controller 390 controls deciding of collapse risk through comparison between the snow load in the collapse risk monitor 340 and that for the structure information of the green house, driving of the snow removal device 220 for each green house 200 via the snow removal device driving controller 360 according to the result of monitoring collapse risk, generating of information data including snowfall amount and snowfall load information stacked on the roof, step-by-step warning information relating to risk of collapse, countermeasures, or combinations thereof according to the collapse risk monitoring results via the information provider 360, and providing the information data to a user terminal 400 through network 100 or displaying the information data on the display 380.

Meanwhile, the snow removal device driving controller 350, the information provider 360, and the display 370 are not necessarily implemented in the green house collapse prevention system, and the implementation of the system can be determined according to the construction environment of the green house collapse prevention system.

For example, if there is no snow removal device in the green house, the snow removal driving controller 350 is not required to be configured, and similarly, if the system environment can process driving of the snow removal device without notifying risk of collapse to a user, the information provider 360 is not necessary to be equipped, and if there is no separate display in the collapse preventing device, the display 370 is also unnecessary to be configured.

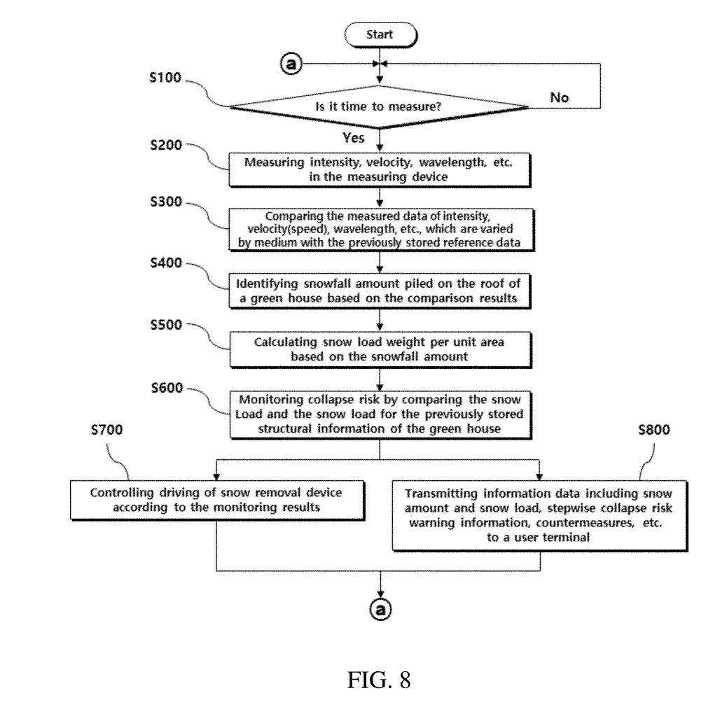

Hereinafter, an embodiment of a method for preventing the green house collapse by the snow load according to the present invention constructed as above will be described in detail with reference to FIG. 8. At this time, each step according to the method of the present invention can be changed in order according to the usage environment or the person skilled in the art.

FIG. 8 is a flowchart for describing in details operational processes of a method for preventing a green house collapse by the snow load in accordance with an embodiment of the present invention.

Firstly, the collapse preventing device 300 determines whether it is time to measure how much amount of snow is accumulated on the roof of the green house 200 to be monitored (S100). That is, it is detected whether it is time for measuring the snowfall amount previously stored in the collapse preventing device 300. The measuring time (time point) can be decided by an operation of a user who manages the green house, and the others can be specified in advance and stored in the storage by pre-specifying the date and time of the snowy season.

As a result of the determination in step S100, if it is time to measure the snowfall amount, the collapse preventing device 300 controls driving of the measuring device 210 installed in the green house 200, and accordingly the measuring device 210 is driven to measure the intensity, speed (velocity), wavelength, or combinations thereof of radio wave that are changed by medium such as vinyl, snow, etc. (S200).

That is, as shown in FIG. 3, in the case of using the measuring module 216 and reflector 218 in which the transmitter 212 and the receiver 214 are integrated, the receiver 214 receives the radar signal output from the measuring module 216 and receives a signal reflected by a reflector 218 provided at a position corresponding to the propagation output direction of the measuring module 216, and then performs measurements including the intensity, speed, wavelength, or combinations thereof of radio waves.

After performing measurements including intensity, speed, wavelength, or combinations thereof in the measuring device 210 through S200, the collapse prevention device 300 receives the measurement data measured in step S200 from the measuring device 210, and then the snowfall amount analyzer 320 compares the measured data with the reference data (i.e., the table data on the propagation characteristics according to the vinyl information and the snowfall amount) previously stored in the storage 380 (S300).

Then the collapse preventing device 300 identifies the thickness of the snow accumulated on the roof of the green house based on the comparison result in step S300 (S400).

After identifying the snow amount through S400, the collapse preventing device 300 calculates the snow load per unit area through the snow load calculator 330 based on the snow accumulation accumulated on the roof of the green house identified in S400 (S500), and the collapsing risk monitor 340 compares the snow load calculated in S500 with the snow load according to the structure information of the green house previously stored in the storage 380, and then monitors whether the green house 200 can withstand the current snow load (S600).

Afterwards, the collapse preventing device 300 controls the driving of the snow removal device including the heating apparatus, the blowing apparatus, the vibration apparatus, or combinations thereof installed in the green house on the basis of collision risk decision result obtained in S600 (S700). At this time, the collapse prevention device 300 may adjust the operation time or intensity of the snow removal device 220 according to each step of deciding the collapse risk (for example, sequential risk steps such as attention, alert (alarm), warning, etc.).

Moreover, the collapse preventing device 300 generates information data including stepwise warning information, countermeasures, or combinations thereof relating to snowfall amount and snowfall load accumulated on the roof of the green house and the collapse risk, based on the collapse risk deciding result obtained in S600, and then transmits the information data to predetermined user terminal 400 via network 100 (S800). At this time, the collapse preventing device 300 may display the information data provided to the user terminal 400 through the display 370.

As described above, according to the present invention, the system provide calculating the snow load on the basis of snow amount measured by using radar sensor, analyzing whether or not the green house can withstand based on the calculated snow load, and then if there is a risk of collapse, driving a snow removal device including a heating device, a blower, a vibration device, or a combination thereof, which are installed in a green house, or sending an emergency message to a user (administrator) terminal, thereby it is effective to prevent a collapse of a green house due to heavy snow that may occur unexpectedly and reduce the cost of economic loss caused by the collapse of the green house.

Moreover, since a single collapse prevention device performs the calculation of the snow load according to the snowfall measurement for each green house in a certain area connected through network, the analysis for the collapse of the structure based on the calculated snow load, and the provision for countermeasures related to snow removal based on the analysis results, it is effective to flexibly construct a green house collapse prevention system according to the location and structure of the green house, and It is effective to construct the system at a relatively low cost and to easily perform the maintenance of the measuring apparatus and the various snow removing apparatus provided in the green house.

Moreover, since the system according to the present invention measures snowfall amount using only small radar sensors and reflectors and calculates the snow load by software processing the measured snowfall amount, it is effectively possible to reduce the installation cost because a separate plate-like facility used for measuring the snow load is not necessary as in the conventional art, and it is also effectively possible to variously change the installing position of the snowfall amount measuring apparatus according to the environments because there is no need to be horizontal with the roof surface of the green house as in the prior art.

The present invention has been described with reference to an embodiment shown in the figures, which is an exemplification only and the various and equivalent embodiments are made possible by those who have ordinary knowledge in the area the present invention belongs to. Therefore, the technical scope of the present invention will be determined by the claims as follows.

What is claimed is:

1. A system for preventing collapse of a green house by snowfall load comprises:
a snowfall load amount analyzer for comparing the measured data measured by a measuring device installed in the green house with the stored reference data and identifying the amount of snow piled on the roof of the green house;
a snowfall load weight calculator for calculating a snow weight per unit area based on the snow piled on the roof of the green house identified by the snowfall load amount analyzer; and
a collapse risk minotor for comparing the snowfall load weight calculated in the snowfall load weight calculator with the previously stored structural weight information for the green house and monitoring whether or not the green house can withstand the snowfall load based on the comparing result.

2. The system of claim 1,
wherein the measured data are the data on the intensity, speed, wavelength of radio waves, or the combinations thereof of radio waves that are changed by the medium of vinyl and snow, and
the reference data are the information data on the vinyl comprising ingredient, material, thickness or the combinations thereof and the propagation characteristics of the radio waves measured in advance according to the snowfall amount, and constructed as a table.

3. The system of claim 1,
wherein the system for preventing collapse of green house by snowfall load further comprises:
a snow removal device driving controller for controlling driving of a snow removing device comprising a heater, a blower, a vibrator, or the combinations thereof installed in the green house on the basis of the result of the collapse risk judgment according to the monitoring result of the collapse risk monitor, and the snow removal device driving controller controls the operation time or intensity of the snow removal device according to each step of the risk of collapse.

4. The system of claim 1,
wherein the system for preventing collapse of the green house further comprises:
an information provider transmitting information data predetermined user terminal via network, in which the information data comprises step-by-step warning information, countermeasures, or the combinations thereof, relating to snowfall amount and snowfall load weight piled on the roof of the green house, based on the decision result of the collapse risk according to the monitoring of the collapse risk monitor; and
a display for displaying the information data comprises step-by-step warning information, countermeasures, or the combinations thereof, relating to snowfall amount and snowfall load weight piled on the roof of the green house generated by the information provider.

5. The system of claim 1,
wherein the measuring device is a radar sensor which a transmitter and a receiver are seperated, and the transmitter and the receiver are separately installed inside or outside the green house.

6. The system of claim 1,
wherein the measuring device comprises:
a measuring module installed inside or outside the green house as a radar sensor integrated with transmitting and receiving functions; and
a reflector installed at a position corresponding to a radio wave output direction of the measuring module and reflecting a radio wave outputted from the measuring module.

7. The system of claim 6,
wherein the reflector is installed outside or inside the roof of the green house, which is a position corresponding to a position of the measuring module installed inside or outside the green house, and
one or more of which the reflector is installed at intervals in the green house.

8. A method for preventing collapse of a green house by snowfall load comprises:
analyzing a snowfall load amount by comparing the measured data measured by a measuring device installed in the green house with the stored reference data and identifying the amount of snow piled on the roof of the green house in an apparatus for preventing collapse of the green house;
calculating a snowfall load weight by calculating a snow weight per unit area based on the snow piled on the roof of the green house identified by the snowfall load amount analyzer in the apparatus for preventing collapse of the green house; and
monitoring a collapse risk by comparing the snowfall load weight calculated in the snowfall load weight calculator with the previously stored structural weight information for the green house and monitoring whether or not the green house can withstand the snowfall load based on the comparing result in the apparatus for preventing collapse of the green house.

9. The method of claim 8,
wherein the measured data are the data on the intensity, speed, wavelength of radio waves, or the combinations thereof of radio waves that are changed by the medium of vinyl and snow, and
the reference data are the information data on the vinyl comprising ingredient, material, thickness or the combinations thereof and the propagation characteristics of the radio waves measured in advance according to the snowfall amount, and constructed as a table.

10. The method of claim 8,
wherein the method for preventing collapse of green house by snowfall load further comprises:
driving a snow removal device by controlling driving of a snow removing device comprising a heater, a blower, a vibrator, or the combinations thereof installed in the green house on the basis of the result of the collapse risk judgment according to the monitoring result of the collapse risk monitoring,
and driving the snow removal device is performing that the snow removal device driving controller controls the operation time or intensity of the snow removal device according to each step of the risk of collapse.

11. The method of claim 8,
wherein the method for preventing collapse of a green house by snowfall load further comprises:
providing an information by transmitting information data predetermined user terminal via network, in which the information data comprises step-by-step warning information, countermeasures, or the combinations thereof, relating to snowfall amount and snowfall load weight piled on the roof of the green house, based on the decision result of the collapse risk according to the monitoring of the collapse risk monitor in the apparatus for preventing collapse of the green house; and
displaying the information data comprises step-by-step warning information, countermeasures, or the combinations thereof, relating to snowfall amount and snowfall load weight piled on the roof of the green house generated by the information provider in the apparatus for preventing collapse of the green house.

12. The method of claim 8,
wherein analyzing a snowfall load amount identifies the snowfall load amount by comparing the measured data in the measuring device with the reference data in which the measuring device is a radar sensor which a transmitter and a receiver are seperated, and the transmitter and the receiver are separately installed inside or outside the green house.

13. The method of claim 8,
wherein analyzing a snowfall load amount identifies the snowfall load amount by comparing the measured data in the measuring device with the reference data, in which the measuring device comprises a measuring module installed inside or outside the green house as a radar sensor integrated with transmitting and receiving functions, and a reflector installed at a position corresponding to a radio wave output direction of the measuring module and reflecting a radio wave outputted from the measuring module,
the reflector is installed outside or inside the roof of the green house, which is a position corresponding to a position of the measuring module installed inside or outside the green house, and
one or more of which the reflector is installed at intervals in the green house.
